(19) United States
(12) Patent Application Publication
(10) Pub. No.: US 2025/0209800 A1
(43) Pub. Date: Jun. 26, 2025

(54) CORESET GENERATION FOR PRETRAINING OF LARGE VISION MODELS

(71) Applicant: Landing AI, Inc., Palo Alto, CA (US)

(72) Inventors: Mark William Sabini, River Edg, NJ (US); Abdelhamid Bouzid, Louisville, KY (US); Bastian Diaz Renjifo, Santiago (CL); Daniel Bibireata, Bellevue, WA (US); Andrew Yan-Tak Ng, Camas, WA (US)

(21) Appl. No.: 18/987,437

(22) Filed: Dec. 19, 2024

Related U.S. Application Data
(60) Provisional application No. 63/612,910, filed on Dec. 20, 2023.

(51) Int. Cl. G06V 10/778; G06V 10/74; G06V 10/77; G06V 10/774

(52) U.S. Cl. CPC G06V 10/778; G06V 10/761; G06V 10/7715; G06V 10/774

(57) ABSTRACT

An application generates feature vectors from a plurality of images, each feature vector summarizing an image of the plurality. The application selects a seed vector from the feature vectors and adds the seed vector to a coreset. The application computes a distance metrics, each distance metric measuring a distance between the seed vector and a given one of the plurality of feature vectors, and adds a feature vector having a largest distance metric relative to all other ones of the distance metrics to the coreset. The application determines a next feature vector to use as a next seed vector based on a nearest neighbor search, and iteratively adds additional ones of the feature vectors to the coreset until a predefined coverage is achieved. The application generates a training set using images of the coreset, the training set used to train a machine learning model to predict features of input images.

### CROSS-REFERENCE TO RELATED APPLICATION

This application claims priority to U.S. Provisional Application No. 63/612,910, filed Dec. 20, 2023, which is incorporated herein by reference in its entirety.

### TECHNICAL FIELD

The disclosure generally relates to the field of machine learning, and more particularly relates to improved mechanisms for pretraining a large models, such as large vision models (LVMs), data summarization models, data compression models, and so on.

### BACKGROUND

LLMs (large-language models) trained on vast quantities of internet data have demonstrated high generality and good zero-shot performance on everyday tasks. LLMs have also found applications within the enterprise space on proprietary company documents. One reason why LLMs work on general text data is because Internet text used to train these models is similar to text used in other applications. That is, understanding grammar and concepts from the former transfers very well to the latter. However, this principle does not neatly transfer to the vision space, because unlike the case for text, Internet images look extremely different from domain-specific (DS) images (e.g., images used in very particular scenarios, such as a manufacturing line for a specific item). As a result, the current off-the-shelf foundation models trained on generic images (typically from datasets like ImageNet, COCO, etc.) exhibit poor performance when used on domain-specific images. The term vision, as used herein, may encompass still images and/or videos, including different modalities, such as thermal, 3D (e.g., MRI/CT), and so on. Wherever vision is referred to herein, audio is also contemplated and the techniques equally apply to audio.

### SUMMARY

Systems and methods are disclosed herein for generating a training set for training a model to predict features of input images in an accurate fashion despite the aforementioned limitations. In some embodiments, an application generates a plurality of feature vectors from a plurality of images, each feature vector summarizing an image of the plurality of images. The application selects a seed vector from the plurality of feature vectors and adding the seed vector to a coreset, and computes a plurality of distance metrics, each distance metric measuring a distance between the seed vector and a given one of the plurality of feature vectors. The application adds a feature vector having a largest distance metric relative to all other ones of the plurality of distance metrics to the coreset, and determines a next feature vector to use as a next seed vector based on a nearest neighbor search. The application iteratively adds additional ones of the plurality of feature vectors to the coreset until a predefined coverage is achieved, and generates a training set using images of the coreset, where the training set is used to train a machine learning model to predict features of input images.

Image coreset generation is merely one embodiment. Coreset generation in other modalities applies generally, where image is only an example. Another embodiment includes data summarization. For example, where a large amount of data is present, the systems and methods disclosed herein may be used to determine diversity within the data, looking at a coreset of the data rather than looking at data elements one by one.

Another embodiment may include data compression, similar to data summarization, where a coreset is generated to reduce the overall “size” of the dataset by intelligent subsampling, thereby yielding a filtered subset that represents the full diversity. Additional embodiments may cover near duplicate detection, where the coreset algorithm naturally filters out near duplicates (as it iteratively selects the most different data points). Yet a further embodiment may include active learning, where, because the coreset may also return an ordering, this can be used to prioritize data samples, either for review or for building a training set.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of an end-to-end data flow for using coresets to pretrain, in accordance with an embodiment.

FIG. 2 illustrates exemplary modules of a large vision module pretraining tool, in accordance with an embodiment, in accordance with an embodiment.

FIGS. 3A-3C illustrate a progressive process for generating a coreset, in accordance with an embodiment, in accordance with an embodiment.

FIG. 4 shows a graph of an example coverage function, in accordance with an embodiment, in accordance with an embodiment.

FIG. 5 depicts an exemplary flowchart of a process for using coresets to pretrain, in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

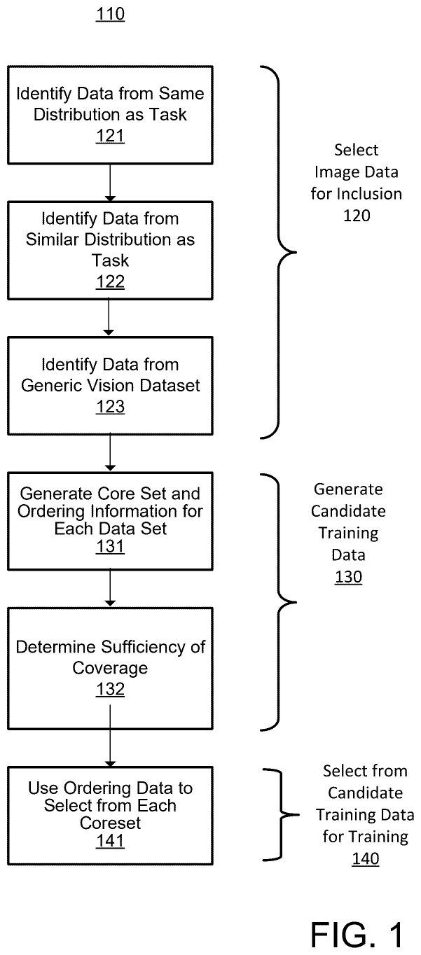

FIG. 1 illustrates one embodiment of an end-to-end data flow for using coresets to pretrain. Process 110 may be executed by one or more processors of a classifier service which may perform pretraining of a large model (e.g., LVM) for classifying domain-specific images. The classifier service may be instantiated by one or more servers, the servers communicatively coupled with one or more client devices by way of a network. The one or more client devices may have an application installed thereon that is designed to interface with the classifier service. For example, the application may be a dedicated application for the classifier service. As another example, the application may be accessed by way of a browser installed on the one or more client devices. Some or all activity discussed in this disclosure with respect to the classifier service may be performed by the client devices, either in distributed fashion or entirely on-premises on one or more of the client devices.

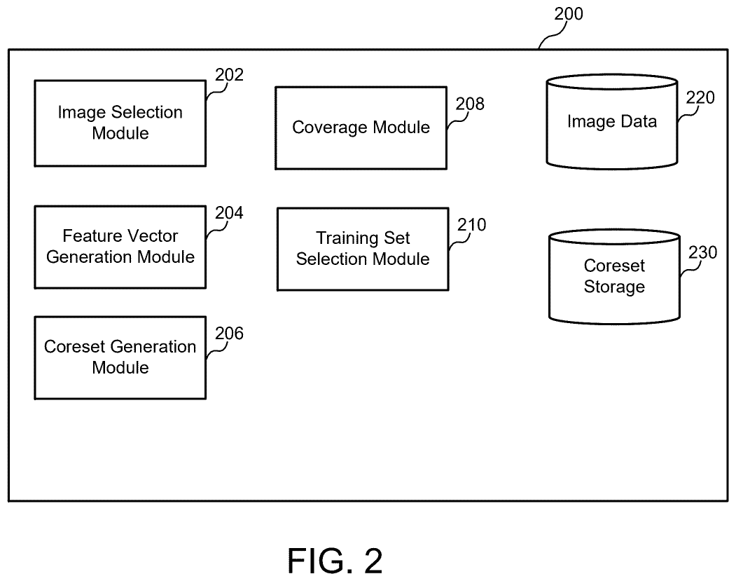

Process 110 begins with the classifier service selecting 120 image data for inclusion as candidate pretraining data. This includes sub-steps of identifying 121 data from a same distribution as a task of the domain-specific images to be classified, identifying 122 data from a similar distribution as the task of the domain-specific images to be classified, and identifying 123 data from generic vision dataset. Together, these identified data sets form candidate image data for pretraining. After the candidate image data is selected, the classifier service generates 130 candidate training data by generating 131 coreset and ordering information for each dataset and determining 132 a sufficiency of coverage of the coresets. Using the coresets, the classifier service selects 140 from the candidate training data a subset for pre-training by using 141 the ordering information to select a subset of candidate data from the coresets. Further details of process 100 are described with respect to activity of particular modules below in connection with at least FIG. 2. As mentioned in the foregoing, images are merely exemplary; tasks of domain-specific data in other modalities may be selected to create coresets for those corresponding tasks.

FIG. 2 illustrates exemplary modules of a large vision module pretraining tool, in accordance with an embodiment. As depicted in FIG. 2, classifier tool 200 includes image selection module 202, feature vector generation module 204, coreset generation module 206, coverage module 208, and training set selection module, as well as image data 220 and coreset storage 230. The modules depicted in FIG. 2 are merely exemplary, and classifier tool 200 may use more or fewer modules and/or databases to effect the functionality described herein.

Image selection module 202 selects images from three different pools of candidate images. The first pool of images is a pool of images from a same domain-specific task as the one for which the model is being trained. For example, on a manufacturing line of blue granite tiles, the first pool of images would be images of blue granite tiles that were produced in prior manufacturing runs. The second pool of images is a pool of images from a similar distribution as the domain-specific task. Following the same example, the second pool of images may include granite tiles of different sizes or colors than the blue granite tiles being produced, and/or may include images of tiles made of different stone than granite (e.g., but are also blue tiles). The third pool of images may include images from generic vision datasets (e.g., images from public Internet databases such as ImageNet, COCO, etc.).

In an embodiment, image selection module 202 selects the images by prompting a human operator to define the first pool, second pool, and third pool (e.g., by inputting the images for each pool and/or inputting a directory where images for each pool can be found). In an embodiment, image selection module 202 selects the images automatically (where other data is used other than images, pools are formed for those other types of data). In some embodiments, all images from each pool go into a coreset algorithm to produce a coreset for each pool. In some embodiments, subsets of images for each pool are selected. In such embodiments, to select the images automatically for the first pool, image selection module 202 may receive one or more seed images representative of the domain-specific task, and may encode that image into a vectorized summary of the image. Image selection module 202 may determine a similarity (e.g., cosine similarity measure, Euclidean similarity measure, etc.) relative to candidate images.

To automatically form pools, image selection module 202 may apply a multi-tiered thresholding, where images having a similarity to the domain-specific image higher than a first threshold (e.g., at least 95% similar) are selected for the first pool, and images having a similarity to the domain-specific images that is between the first threshold and a second threshold (e.g., 90%-95%) are selected for the second pool. In an embodiment, image selection module 202 may use a generic database for the third pool. In another embodiment, image selection module 202 may select images for the third pool that have below the second threshold similarity to the domain-specific image for usage in the third pool, optionally applying a lower bound threshold (e.g., 50%).

After the images in each pool are selected, feature vector generation module 204 generates feature vectors for each image. Feature vector generation module 204 may generate the feature vectors by inputting the images into a feature extraction model. The feature extraction model may be trained on a large amount of images that may be generic images. In another embodiment, the feature extraction model may be pretrained in a self-supervised fashion on images sampled from the first pool, second pool, and third pool in order to improve the quality of the feature vectors. The feature vectors may be embeddings that describe in latent space aspects of the images in any number of dimensions, the feature vectors summarizing each image.

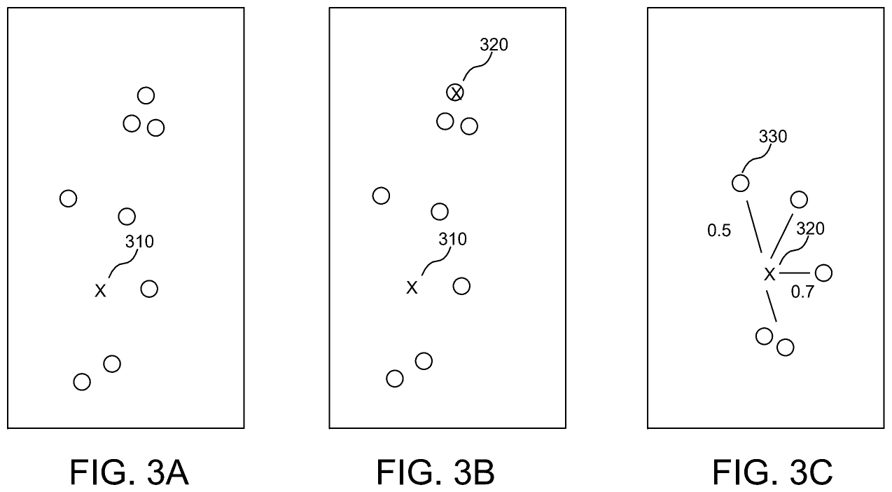

Coreset generation module 206 generates, for each pool of images, a respective coreset of images. The term coreset, as used herein, may refer to a subset of images from each pool that is representative of a minimum coverage of features. The minimum coverage of features may be predefined as a default or may be defined or adjusted by a user. To illustrate how a coreset is generated, we turn to FIGS. 3A-3C. FIGS. 3A-3C illustrate a progressive process for generating a coreset, in accordance with an embodiment. Coreset generation module 206 selects a feature vector as seed 310, as shown in FIG. 3A. The selection may be random or according to any heuristic. Coreset generation module 206 adds seed 310 to the coreset. After selecting seed 310, coreset generation module 206 determines a similarity metric between seed 310 and each other candidate feature vector within the pool of images. The similarity metric is described here as a cosine distance for illustrative purposes, but may be any other measure of similarity (e.g., Euclidean similarity, etc.).

After determining the similarity metric for each other feature vector, coreset generation module 206 determines a feature vector 320 that is furthest from the seed, as shown in FIG. 3B. Coreset generation module 206 identifies the further vector to ensure that maximum diversity is present in the coreset. That is, as the algorithm iterates, the furthest feature vectors are continually identified until a coverage target is achieved, therefore ensuring a maximum amount of maximally different images are included. Coreset generation module 206 adds feature vector 320 to the coreset.

After feature vector 320 is identified, a nearest neighbor search is performed with respect to feature vector 320, as depicted in FIG. 3C. For all resulting neighbors, a similarity metric is determined (e.g., cosine similarity). A least similar feature vector 330 with respect to feature vector 320 and with respect to seed 310 is added to the coreset by coreset generation module 206. Determining a least similar feature vector 330 with respect to both feature vector 320 and seed 310 ensures that a maximally different feature vector with respect to all vectors already selected in the coreset is selected. Coreset generation module 206 adds feature vector 330 to the coreset. Coreset generation module 206 determines the current coverage based on the similarity metric. The coverage metric measures the maximum distance (or lowest similarity) from all points not in the coreset, to any point within the coreset (so far). In order for the bound to be tight and as strict as possible, given the least similar feature vector (which we selected as 330 in this step), coreset generation module 206 determines how maximally similar it is to anything in the coreset. For example, if the system is at a stage where the least similar feature vector is already very close to something in the coreset (say a similarity of 0.95), then the system has achieved coverage of a large majority of the space.

That is, as shown in FIG. 3C, the maximum cosine similarity between the most recently added feature vector 330 and each of the other members of the coreset (feature vector 320 and seed 310) is 0.7, and therefore the current coverage is 0.7 . . . . Coreset generation module 206 determines whether the current coverage is equal to or greater than the target coverage (e.g., a target coverage of 0.8). Responsive to determining that the current coverage is not equal to or greater than the target coverage, the process described with respect to FIG. 3C repeats, where a nearest neighbor search is performed with respect to feature vector 330 and a least similar neighbor is identified and added to the coreset, where this iterates (e.g., where maximum difference of nearest neighbors is compared to all vectors in the coreset (which expands on each iteration) until the target coverage is achieved.

In some embodiments, coreset generation module 206 annotates feature vectors that are added to a coreset with a sequence marker. The sequence marker indicates an order in which feature vectors are added to the coreset, and may be used downstream in the process to determine, from the coreset for each pool, which images within the coreset are to be used as training data, as will be described below with respect to training set selection module 210. The following is a pseudocode of a process that reflects the activity of coreset generation module 206.

Given a set of vectors V_all:

Initialize an (ordered) list of vectors V_selected

Initialize an (ordered) list of coverage scores C

Select a seed vector v0 (e.g., at random), and add it to V_selected

While there are unselected vectors (aka V_all\V_selected is not empty):

For each unselected vector v′in V_all\V_selected:

Compute its similarity to the coreset V_selected, defined as sim (v′, V_selected)=max_{v\in V_selected} cos_sim (v, v′)

The current coverage c is then defined as min_{v′\in V_all\V_selected}max_{v \in V_selected}cos_sim (v, v′). In other words, with a target coverage of c, all unselected vectors have a similarity of at least c to something in the coreset.

Append the current coverage c to the list of coverage scores C

Select the vector v*in V_all\V_selected with the lowest similarity to the coreset, v*=argmin_{v′\in V_all\V_selected}max_{v \in V_selected} cos_sim (v, v′)

Add v* to V_selected

Output V_selected, C

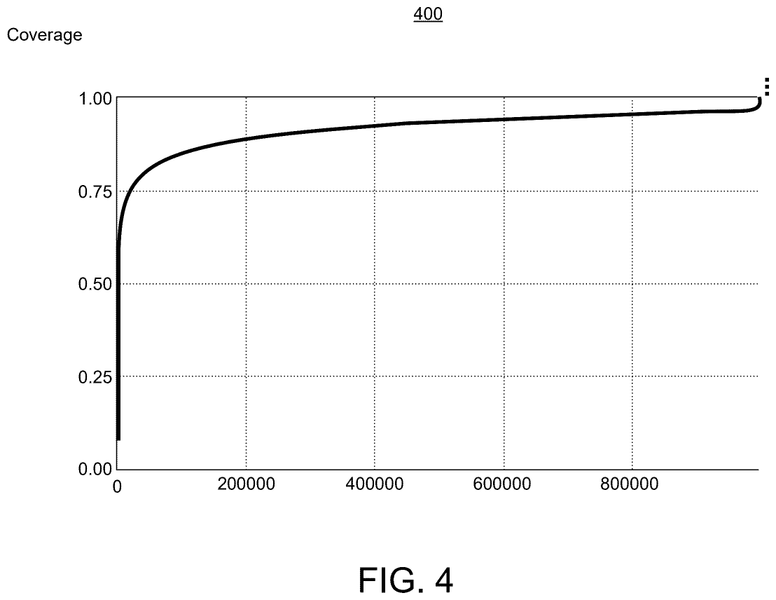

Coverage module 208 is used to select target coverage and to monitor current coverage of a given coreset. Coverage is a measure of how representative a coreset is of a given set of images. That is, as feature vectors are added to the coreset, there are fewer and fewer features that are not covered by the coreset. At some point that is typically achieved sooner than adding all feature vectors to the coreset, all features are covered, and therefore coverage jumps to 100. This is shown in FIG. 4. FIG. 4 shows a graph of an example coverage function, in accordance with an embodiment. As shown in FIG. 4, coverage relative to coreset size is a monotonic function (because coverage cannot go down as feature vectors are added), where coverage increases first quickly, then slowly, as the coreset grows. It can be seen that there is an inflection point (in graph 400, around a coverage of 0.8) where diminishing returns are made when feature vectors are added to the coreset. Additionally, it can be seen that coverage jumps to 1.00 when all features are covered, without a need to increase the coreset size from there.

Coverage module 208 determines a target coverage, either by determining a default amount, or by receiving user input that defines the target coverage. The target coverage may be adjusted by a user during or even after the process of coreset generation, which if adjusted upward, would cause coreset generation to resume from where it was left off. Coverage module 208 may alternatively or additionally select a default target coverage based on the “knee” of the coreset function (as determined using any knee-finding algorithm). For example, when a knee is reached, coverage module 208 may determine that a target coverage has been reached.

Coverage module 208 may determine whether the coreset has, at each given iteration, reached the target coverage. Responsive to determining that the target coverage is reached, coverage module 208 may instruct the iterations to cease. Coverage module 208 may store the coreset to coreset storage 230 along with ordering data and achieved coverage. Should coverage wish to be increased later on, the coreset could be retrieved and supplemented using further iterations until an adjusted coverage is reached.

Training set selection module 210 selects images (or other data) from each of the three pools to use for pretraining. The first pool is the highest priority because it has coverage of images of the same domain-specific task. The second pool is the next highest priority because it has coverage of images of similar domain-specific tasks. The third pool is lowest priority. In an embodiment, training set selection module 210 selects as training data all images from the first pool and the second pool that have feature vectors in their respective coresets, and excludes images from the first pool and the second pool that do not have feature vectors in their respective coresets. Training set selection module 210 then caps the images from the third pool based on percentage. For example, a maximum percentage may be defined by default or by a human administrator, such as 20%, where this percentage defines a maximum amount of the training set that can be taken up by images from the third pool. The amount of images (or other data) that corresponds to the percentage may be determined based on the amount of images taken from the first pool and the second pool. The ordered images (or other data) from the third pool may then be taken in order until the predefined percentage is reached, excluding from the training data the images (or other data) not in the coreset of the third pool and having a sequence marker that does not fit within the allowed percentage.

In some embodiments, the coreset for the third pool may be calculated in advance and reused across projects, given that the databases may include a static set of images (or other data) and therefore the coreset does not change. Coreset generation module 206 may periodically determine whether a database has changed and may responsive to detecting a change update the coreset for that public database. Therefore, as new domain-specific models are to be pretrained, a cached coreset for the third pool may be used rather than generating a new one, saving on processing power and efficiency. Images (or other data) from each pool and/or images selected for pretraining may be stored to image data 220.

In some embodiments, to improve efficiency in generating the coresets, coreset generation module 206 may optimize the coreset generation by running the coreset generations on multiple GPUs. To achieve this, coreset generation module 206 may break the feature vectors into different segments of feature vectors, and have different GPUs perform the similarity analysis across feature vectors in parallel. After the segments are processed by their respective GPUs, they may be re-aggregated at a single GPU to perform a global analysis across feature vectors that were not previously compared in order to ensure maximum diversity across segments. By performing this in a parallel manner, scaling is improved (e.g., to an analysis of tens of millions or more of images) where processing time may be cut by one or more orders of magnitude depending on how many GPUs are available to spread the load across.

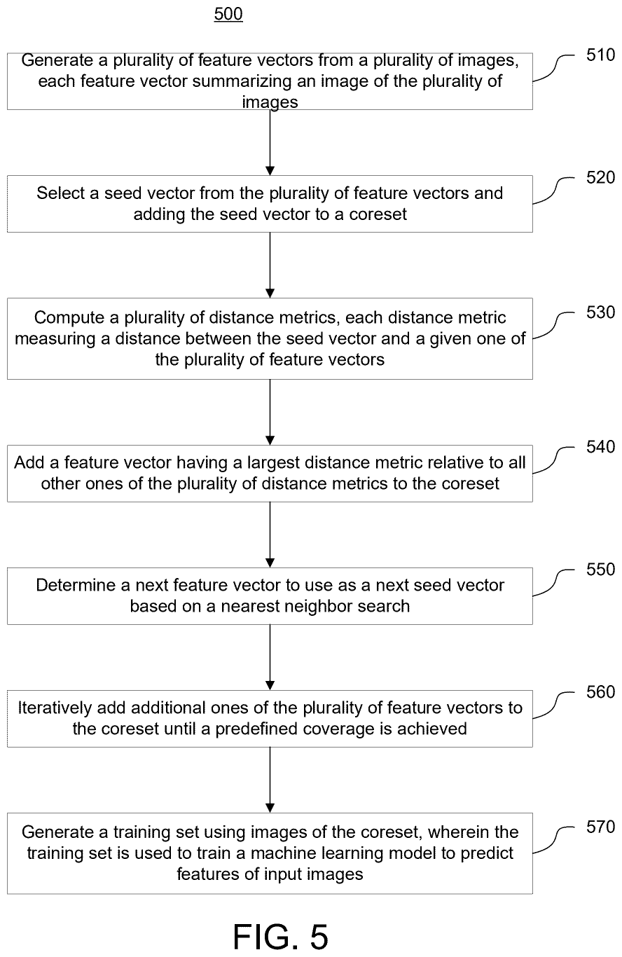

FIG. 5 depicts an exemplary flowchart of a process for using coresets to pretrain, in accordance with an embodiment. Process 500 may be executed by one or more processors executing instructions that cause the modules of classification tool 200 to perform operations. Process 500 begins with classification tool 200 generating 510 a plurality of feature vectors from a plurality of images, each feature vector summarizing an image of the plurality of images (e.g., using feature vector generation module 204). Classification tool 200 selects 520 a seed vector from the plurality of feature vectors and adding the seed vector to a coreset (e.g., using coreset generation module 206).

Classification tool 200 computes 530 a plurality of distance metrics, each distance metric measuring a distance between the seed vector and a given one of the plurality of feature vectors, and adds 540 a feature vector having a largest distance metric relative to all other ones of the plurality of distance metrics to the coreset (e.g., using coreset generation module 206). Classification tool 200 determines 550 a next feature vector to use as a next seed vector based on a nearest neighbor search (e.g., using coreset generation module 206), and iteratively adds 560 additional ones of the plurality of feature vectors to the coreset until a predefined coverage is achieved (e.g., as determined using coverage module 208). Classification tool 200 generates 570 a training set using images of the coreset, where the training set is used to train a machine learning model to predict features of input images (e.g., using training set selection module 210).

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for a training large models (e.g., LVMs) through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
generating a plurality of feature vectors from a plurality of images, each feature vector summarizing an image of the plurality of images;
selecting a seed vector from the plurality of feature vectors and adding the seed vector to a coreset;
computing a plurality of distance metrics, each distance metric measuring a distance between the seed vector and a given one of the plurality of feature vectors;
adding a feature vector having a largest distance metric relative to all other ones of the plurality of distance metrics to the coreset;
determining a next feature vector to use as a next seed vector based on a nearest neighbor search;
iteratively adding additional ones of the plurality of feature vectors to the coreset until a predefined coverage is achieved; and
generating a training set using images of the coreset, wherein the training set is used to train a machine learning model to predict features of input images.

2. The method of claim 1, wherein the plurality of images comprises a first set of images formed from a same task as a task represented by the input images, a second set of images formed by a different task as the task represented by the input images but having at least a threshold similarity metric to the same task, and a third set of images having a high diversity and taken from a public data set.

3. The method of claim 2, wherein separate coresets are formed for each of the first set of images, the second set of images, and the third set of images, the first set of images corresponding to a first coreset, the second set of images corresponding to a second coreset, and the third set of images corresponding to a third coreset.

4. The method of claim 3, wherein the training set comprises all of the images in the first coreset and the second coreset, and wherein the training set comprises a truncated amount of images in the third coreset based on a size of the first coreset and the second coreset.

5. The method of claim 1, wherein determining the next feature vector to use as the next seed vector based on the nearest neighbor search comprises:
performing the nearest neighbor search with respect to the feature vector having the largest distance metric relative to all other ones of the plurality of distance metrics to the coreset; and
determining the next feature vector to be, as indicated by the nearest neighbor search, one having a lowest cosine similarity to the feature vector having the largest distance metric relative to all other ones of the plurality of distance metrics to the coreset.

6. The method of claim 1, wherein the predefined coverage is specified by a user.

7. The method of claim 1, wherein as the additional ones of the plurality of feature vectors are added to the coreset, an order in which they are added is stored to memory.

8. The method of claim 7, wherein the training set is at least partially generated based on the order.

9. A non-transitory computer-readable medium comprising memory with instructions encoded thereon, the instructions, when executed by one or more processors, causing the one or more processors to perform operations, the instructions comprising instructions to:
generate a plurality of feature vectors from a plurality of images, each feature vector summarizing an image of the plurality of images;
select a seed vector from the plurality of feature vectors and adding the seed vector to a coreset;
compute a plurality of distance metrics, each distance metric measuring a distance between the seed vector and a given one of the plurality of feature vectors;
add a feature vector having a largest distance metric relative to all other ones of the plurality of distance metrics to the coreset;
determine a next feature vector to use as a next seed vector based on a nearest neighbor search;
iteratively add additional ones of the plurality of feature vectors to the coreset until a predefined coverage is achieved; and
generate a training set using images of the coreset, wherein the training set is used to train a machine learning model to predict features of input images.

10. The non-transitory computer-readable medium of claim 9, wherein the plurality of images comprises a first set of images formed from a same task as a task represented by the input images, a second set of images formed by a different task as the task represented by the input images but having at least a threshold similarity metric to the same task, and a third set of images having a high diversity and taken from a public data set.

11. The non-transitory computer-readable medium of claim 10, wherein separate coresets are formed for each of the first set of images, the second set of images, and the third set of images, the first set of images corresponding to a first coreset, the second set of images corresponding to a second coreset, and the third set of images corresponding to a third coreset.

12. The non-transitory computer-readable medium of claim 11, wherein the training set comprises all of the images in the first coreset and the second coreset, and wherein the training set comprises a truncated amount of images in the third coreset based on a size of the first coreset and the second coreset.

13. The non-transitory computer-readable medium of claim 9, wherein the instructions to determine the next feature vector to use as the next seed vector based on the nearest neighbor search comprise instructions to:
perform the nearest neighbor search with respect to the feature vector having the largest distance metric relative to all other ones of the plurality of distance metrics to the coreset; and
determine the next feature vector to be, as indicated by the nearest neighbor search, one having a lowest cosine similarity to the feature vector having the largest distance metric relative to all other ones of the plurality of distance metrics to the coreset.

14. The non-transitory computer-readable medium of claim 9, wherein the predefined coverage is specified by a user.

15. The non-transitory computer-readable medium of claim 9, wherein as the additional ones of the plurality of feature vectors are added to the coreset, an order in which they are added is stored to memory.

16. The non-transitory computer-readable medium of claim 15, wherein the training set is at least partially generated based on the order.

17. A system comprising:
memory with instructions encoded thereon; and
one or more processors that, when executing the instructions, are caused to perform operations comprising:
generating a plurality of feature vectors from a plurality of images, each feature vector summarizing an image of the plurality of images;
selecting a seed vector from the plurality of feature vectors and adding the seed vector to a coreset;
computing a plurality of distance metrics, each distance metric measuring a distance between the seed vector and a given one of the plurality of feature vectors;
adding a feature vector having a largest distance metric relative to all other ones of the plurality of distance metrics to the coreset;
determining a next feature vector to use as a next seed vector based on a nearest neighbor search;
iteratively adding additional ones of the plurality of feature vectors to the coreset until a predefined coverage is achieved; and
generating a training set using images of the coreset, wherein the training set is used to train a machine learning model to predict features of input images.

18. The system of claim 17, wherein the plurality of images comprises a first set of images formed from a same task as a task represented by the input images, a second set of images formed by a different task as the task represented by the input images but having at least a threshold similarity metric to the same task, and a third set of images having a high diversity and taken from a public data set.

19. The system of claim 18, wherein separate coresets are formed for each of the first set of images, the second set of images, and the third set of images, the first set of images corresponding to a first coreset, the second set of images corresponding to a second coreset, and the third set of images corresponding to a third coreset.

20. The system of claim 19, wherein the training set comprises all of the images in the first coreset and the second coreset, and wherein the training set comprises a truncated amount of images in the third coreset based on a size of the first coreset and the second coreset.
